(19) United States
(12) Patent Application Publication
(10) Pub. No.: US 2013/0239388 A1
(43) Pub. Date: Sep. 19, 2013

(54) EXTENSION LADDER SLIPPAGE AND DAMAGE REDUCTION PAD

(71) Applicant: Daniel Edward Striepling, Muskego, WI (US)

(72) Inventor: Daniel Edward Striepling, Muskego, WI (US)

(21) Appl. No.: 13/844,263

(22) Filed: Mar. 15, 2013

Related U.S. Application Data
(60) Provisional application No. 61/611,167, filed on Mar. 15, 2012.

(51) Int. Cl. E06C 7/18

(52) U.S. Cl. CPC E06C 7/188
USPC 29/428; 428/99

(57) ABSTRACT

A set of pads, such as rubber pads, can be used with an extension ladder to reduce slipping and prevent damage to the structure on which it is placed. The rubber pads can be attached to the side rails of the extension ladder at a predetermined height. When the ladder is placed against an eave or gutter of the structure, the rubber pads provide a slip resistant protective barrier.

### CROSS-REFERENCE TO RELATED APPLICATION

This application claims the benefit of priority of U.S. provisional application No. 61/611,167, filed Mar. 15, 2012, the contents of which are herein incorporated by reference.

### BACKGROUND OF THE INVENTION

The present invention relates to ladder accessories and, more particularly, to a set of pads, such as rubber pads, for use with an extension ladder to reduce slippage and damage.

Extension ladders are often placed against a structure to reach a roof level thereof. These extension ladders are usually made of fiberglass or aluminum and the ladders are often placed against an eave or a gutter.

The friction between the ladder rails and the structure (the eaves or gutter) is minimal and the ladder can easily slide therealong. When the ladder is able to slide along the structure, the user's safety can be at risk. Should the ground settle or the user shift their weight on the ladder, it may slide along the structure and fall.

Moreover, a ladder rails on a structure, such as on a building's gutters, can cause damage to the gutters, possibly scraping paint away from the gutters or causing a dent to the gutters.

As can be seen, there is a need for a device to increase friction between a ladder placed against a structure while also reducing or eliminating damage to the structure.

### SUMMARY OF THE INVENTION

In one aspect of the present invention, a extension ladder slip and damage reduction pad comprises a pad body; a first strap disposed through first and second strap slots disposed proximate to a first end of the pad body; a second strap disposed through third and fourth strap slots disposed proximate to a second, opposite end of the pad body; and attachment mechanisms disposed to adjustably attach ends of the first strap together and to adjustably attach ends of the second strap together.

In another aspect of the present invention, a extension ladder slip and damage reduction pad comprises a rubber pad body; a first strap disposed through first and second strap slots disposed proximate to a first end of the pad body; a second strap disposed through third and fourth strap slots disposed proximate to a second, opposite end of the pad body; attachment mechanisms disposed to adjustably attach ends of the first strap together and to adjustably attach ends of the second strap together; and a male buckle disposed proximate to a first end of the first and second straps and a female buckle disposed proximate to a second, opposite end of the first and second straps.

In a further aspect of the present invention, a method for reducing slippage of a ladder placed against a structure comprises attaching pads to a portion of rails of an extension ladder, the pads having a pad body, a first strap disposed through first and second strap slots disposed proximate to a first end of the pad body, a second strap disposed through third and fourth strap slots disposed proximate to a second, opposite end of the pad body, and attachment mechanisms disposed to adjustably attach ends of the first strap together and to adjustably attach ends of the second strap together; and placing the extension ladder against the structure so that the pads are disposed between the extension ladder and the structure.

These and other features, aspects and advantages of the present invention will become better understood with reference to the following drawings, description and claims.

### BRIEF DESCRIPTION OF THE DRAWINGS

FIG. 1 is a perspective view of an extension ladder rail pad, in use on a ladder placed against a structure, according to an exemplary embodiment of the present invention;

FIG. 2 is a perspective view of the extension ladder rail pad of FIG. 1; and

FIG. 3 is a side view of the extension ladder rail pad of FIG. 1, in use on a ladder placed against a structure.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a set of pads, such as rubber pads, for use with an extension ladder to reduce slipping and prevent damage to the structure on which it is placed. The rubber pads can be attached to the side rails of the extension ladder at a predetermined height. When the ladder is placed against an eave or gutter of the structure, the rubber pads provide a slip resistant protective barrier.

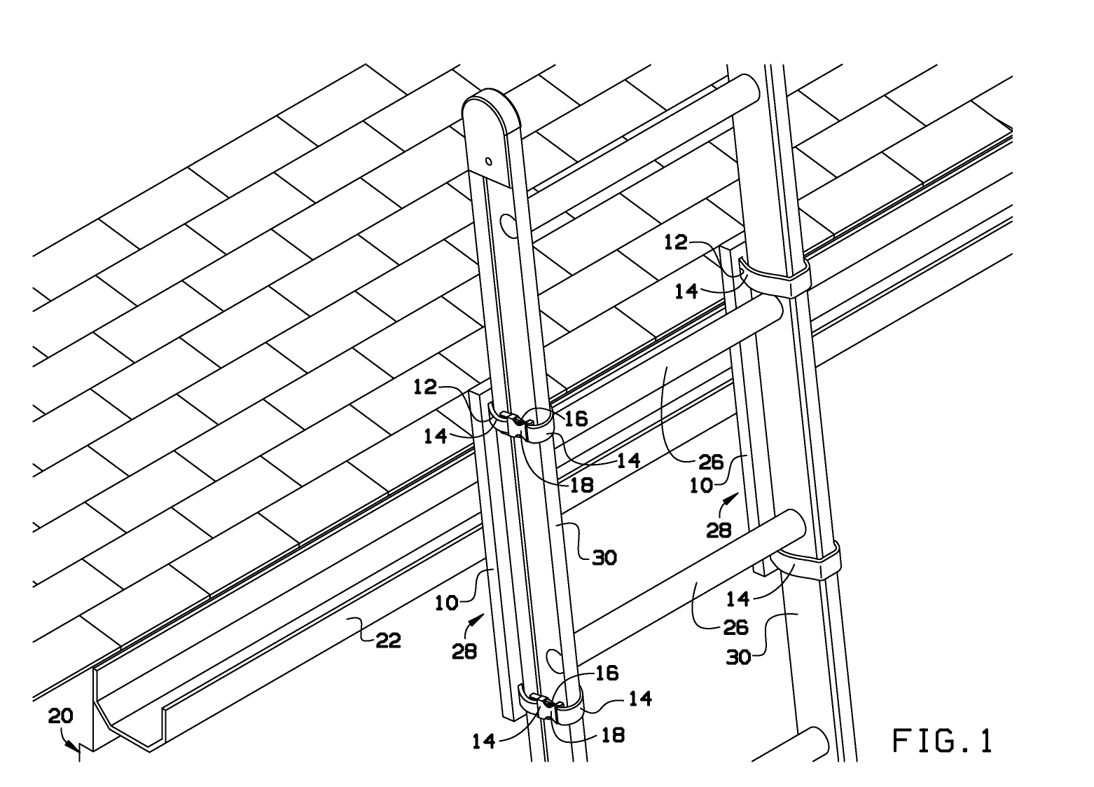

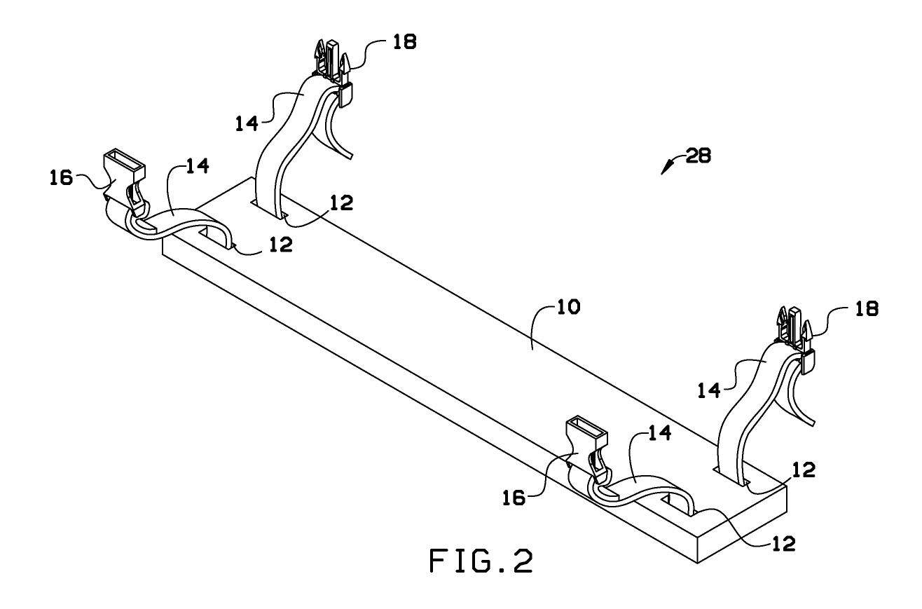

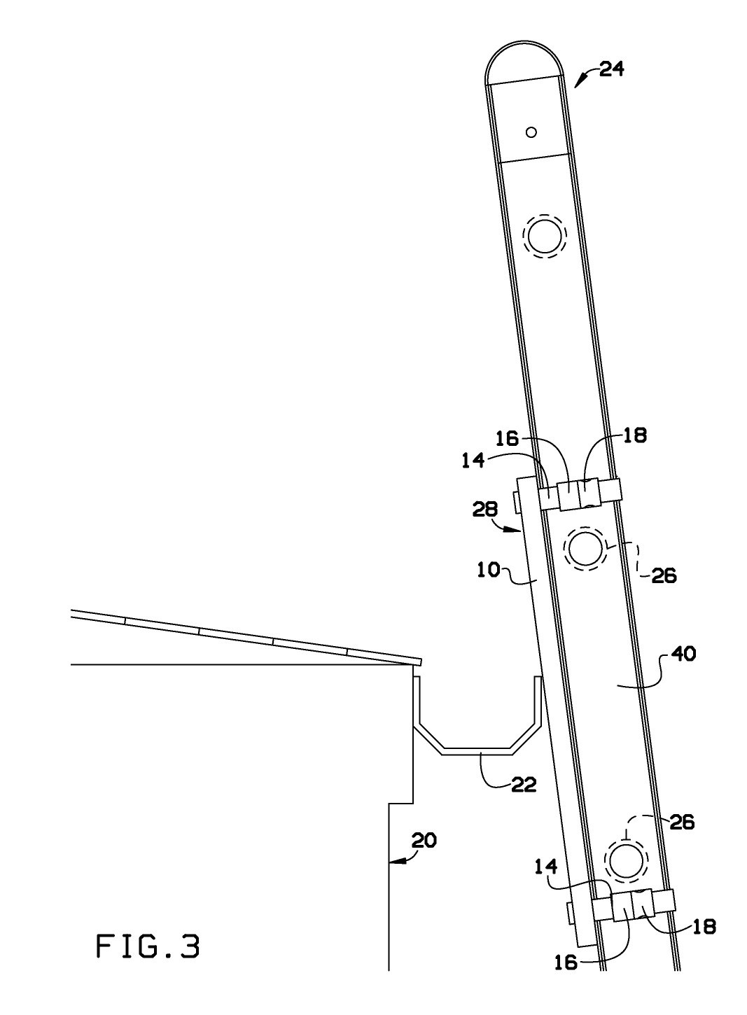

Referring to FIGS. 1 through 3, a rubber pad 28 can include a pad body 10 having a first and second set of strap slots 12 disposed at ends of each end of the body 10. Typically, the strap slots 12 are disposed at corners of the body 10. The strap slots 12 can be sized to receive a strap 14 therethrough.

A female buckle 16 can be disposed at one end of the strap 14 and a male buckle 18 can be disposed at the other end of the strap 14 and one strap can be disposed at each end of the body 10 of the rubber pad 28. The strap 14 can be threaded through one or both of the male buckle 18 and the female buckle 16 in an adjustable manner so that the length of the strap 14 can be adjusted.

The rubber pad 28 can be applied to a rail 30 of an extension ladder 24 by wrapping the straps 14 around the rail 30 and inserting the male buckle 18 into the female buckle 16 and tightening the strap 14. The rubber pad 28 can be placed on any location along the ladder rail 30. In some embodiments, the rubber pad 28 can be placed so that one of the straps 14 can be wrapped around the rail 30 above one ladder rung 36 and the other strap 14 can be wrapped below one lower ladder rung 36, thereby preventing movement up and down the extension ladder 24.

As shown in the Figures, the extension ladder 24 can, with the rubber pads 28 attached, be placed against a gutter 22 of a structure 20. The rubber pads 28 create an increased friction between the ladder 24 and the gutter 22, virtually eliminating the possibility of the ladder slipping during use. Moreover, the rubber pads 28 can help prevent damage from the ladder rails 30 contacting the gutters 22.

The straps can be formed from various strapping material and can typically be about 1 inch wide and from about 20 to 25 inches long. The body 10 of the rubber pads 28 can be formed, for example, from sheet rubber that is about ½ to about 1-inch thick, typically about ¾ inch thick.

While the above describes a rubber pad 28, the pad can actually be formed from various materials, provided that the material provides an increased friction as compared to the ladder alone being rested directly against the structure.

It should be understood, of course, that the foregoing relates to exemplary embodiments of the invention and that modifications may be made without departing from the spirit and scope of the invention as set forth in the following claims.

What is claimed is:

1. An extension ladder slip and damage reduction pad, comprising:
a pad body;
a first strap disposed through first and second strap slots disposed proximate to a first end of the pad body;
a second strap disposed through third and fourth strap slots disposed proximate to a second, opposite end of the pad body; and
attachment mechanisms disposed to adjustably attach ends of the first strap together and to adjustably attach ends of the second strap together.

2. The extension ladder slip and damage reduction pad of claim 1, further comprising a male buckle disposed proximate to a first end of the first and second straps and a female buckle disposed proximate to a second, opposite end of the first and second straps.

3. The extension ladder slip and damage reduction pad of claim 1, wherein the pad body is formed of a material providing increased friction between an extension ladder and a structure as compared to the extension ladder being disposed directly to the structure.

4. The extension ladder slip and damage reduction pad of claim 3, wherein the pad body is formed of rubber.

5. The extension ladder slip and damage reduction pad of claim 1, wherein the pad body is from about ½ to about 1 inch in thickness.

6. An extension ladder slip and damage reduction pad, comprising:
a rubber pad body;
a first strap disposed through first and second strap slots disposed proximate to a first end of the pad body;
a second strap disposed through third and fourth strap slots disposed proximate to a second, opposite end of the pad body;
attachment mechanisms disposed to adjustably attach ends of the first strap together and to adjustably attach ends of the second strap together; and
a male buckle disposed proximate to a first end of the first and second straps and a female buckle disposed proximate to a second, opposite end of the first and second straps.

7. The extension ladder slip and damage reduction pad of claim 6, wherein the pad body is from about ½ to about 1 inch in thickness.

8. A method for reducing slippage of a ladder placed against a structure, the method comprising:
attaching pads to a portion of rails of an extension ladder, the pads having a pad body, a first strap disposed through first and second strap slots disposed proximate to a first end of the pad body, a second strap disposed through third and fourth strap slots disposed proximate to a second, opposite end of the pad body, and attachment mechanisms disposed to adjustably attach ends of the first strap together and to adjustably attach ends of the second strap together; and
placing the extension ladder against the structure so that the pads are disposed between the extension ladder and the structure.
